(19) United States
(12) Patent Application Publication
(10) Pub. No.: US 2026/0195782 A1
(43) Pub. Date: Jul. 9, 2026

(54) SYSTEMS AND METHODS FOR DERIVATION OF ENHANCED DATA INDICATORS

(71) Applicant: MASTERCARD INTERNATIONAL INCORPORATED, PURCHASE, NY (US)

(72) Inventors: Sooraj JAISANKAR, Gurugram (IN); Christian HYLANDER, Schriek (BE); Devesh BANSAL, Delhi (IN); Upasana KALRA, Faridabad (IN)

(21) Appl. No.: 19/435,188

(22) Filed: Dec. 29, 2025

Related U.S. Application Data
(60) Provisional application No. 63/742,342, filed on Jan. 6, 2025.

(51) Int. Cl. G06Q 30/0203; G06Q 10/02

(52) U.S. Cl. CPC G06Q 30/0203; G06Q 10/02

(57) ABSTRACT

Systems and methods are provided for derivation of enhanced data indicators. One example computer-implemented method includes, in response to a request for data indicators, from a first travel provider, accessing transaction data representative of a plurality of transactions based on an amount of the plurality of transactions and a category of the first party involved in the plurality of transactions; classifying the plurality of transaction as core service transactions or ancillary service transactions, using a machine learning model; classifying the ancillary service transactions, using a second machine learning model, by type of ancillary service; clustering users associated with the transactions into segments, based at least on non-travel transactions of the plurality of transactions; and for each segment, compile a data structure of the a count of ancillary transaction for the first travel provider relative to one or more competitor travel providers.

### CROSS-REFERENCE TO RELATED APPLICATION

This application claims the benefit of, and priority to, U.S. Patent Application No. 63/742,342, filed on Jan. 6, 2025. The entire disclosure of the above application is incorporated herein by reference.

### FIELD

The present disclosure generally relates to systems and methods for use in derivation of enhanced data indicators, and in particular, to derivation of enhanced data indicators from limited data, where the data indicator(s) provide insights as to persons engaged in the underling interactions.

### BACKGROUND

This section provides background information related to the present disclosure which is not necessarily prior art.

Data analytics are used in connection with operational decisions and efficiencies in a number of different industries. The airline industry, for example, relies on data associated with the sales of tickets, and also data related to flights, seasonality, seat occupancy rates (e.g., in general, or by class, etc.), etc., to plan flights to specific destinations. Beyond flight planning, the analytics associated with airline data may provide insights into other offers related to airline tickets. The data may be sourced from the airlines, or from other sources, such as, for example, transaction data, etc.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in derivation of enhanced data indicators;

FIG. 2 is a block diagram of an example computing device that may be used in the system of FIG. 1;

FIG. 3 is an example method for derivation of enhanced data indicators that may be implemented in the system of FIG. 1; and

FIG. 4 is an example data structure including counts of ancillary service transactions, which may be used in the system of FIG. 1 and/or the method of FIG. 3, for derivation of enhanced data indicators.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

In connection with data analytics, as it related to airline services, for example, sources of data may be limited to specific airlines, or by transaction data limited to specific accounts. In the former category, the data is limited to the specific persons that make purchases with the specific airline (i.e., Airline A for example has limited, or no, insight into what persons purchase from Airline B, and vice-versa). As it relates to transaction data, the data is often agnostic as to the particular basis for the amount being charged (i.e., ticket, upgrade (e.g., class, etc.), baggage services, meal services, etc.) (i.e., the transaction data includes a total amount, which may include the ticket, or the ticket and baggage, or ticket and upgrade, etc.). In this way, the limited data content, or source, defines a technical problem whereby data indicators that may be derived from more robust data are simply not available. A technical solution is needed to effectively derive data indicators from the limited forms of data available in certain instances, industries, etc.

Uniquely, the systems and methods herein provide for derivation of enhanced data indicators from limited data, where the data indicator(s) provide insights as to specific persons and/or categories of persons engaged in the underling interactions.

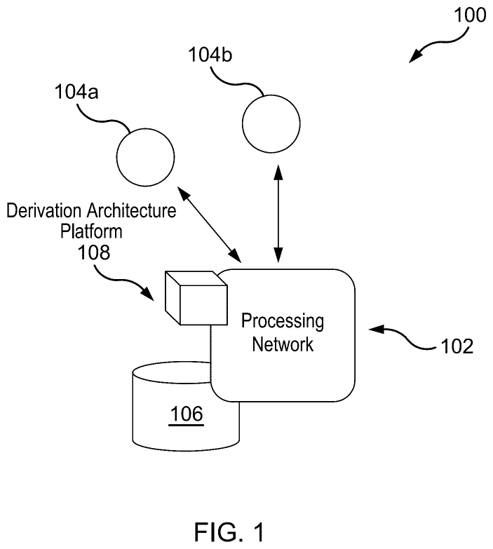

FIG. 1 illustrates an example system 100, in which one or more aspects of the present disclosure may be implemented. Although the system 100 is presented in one arrangement, other embodiments may include systems arranged otherwise depending, for example, on travel patterns and/or purchases, data privacy rules and regulations, etc.

The system 100 generally includes a payment processing network 102 and multiple transit providers 104a-b, each coupled in communication, via one or more networks. The networks are represented by the arrowed lines in FIG. 1, and may each include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this embodiment, the processing network 102 is configured to facilitate payment transactions between different financial institutions (not shown) (e.g., issuers of accounts to customers, travel providers, etc.), on behalf of the travel providers 104a-b and customers of the travel providers 104a-b. The processing network 102 may include, for example, one or more of the MASTERCARD, VISA, DISCOVER, etc., processing networks.

In connection therewith, authorization messages (e.g., ISO 8586 messages, ISO 2022 messages, etc.) are passed to the processing network 102, from financial institutions (e.g., banks, credit unions, card issuers, etc.) associated with the travel providers 104a-b and consumers (broadly, users) interacting with the travel providers 104a-b, whereby the processing network 102 is configured to transmit the authorization messages between and along to financial institutions (e.g., to facilitate authorization between an acquiring bank associated with the travel provider and an issuing bank associated with the customer, etc.). Consequently, the processing network 102 is further configured to compile, collect, and store, in database 106, transaction data which is representative of the transactions. The transaction data includes a plurality of transaction records, one for each transaction, or attempted transaction. The transaction data may include, for example, payment account numbers, customer names and addresses, amounts of the transactions (e.g., total amount, etc.), merchant data (e.g., for the travel providers 104a-b, etc.) (e.g., identifiers, names, addresses, merchant category codes (MCCs), terminal IDs, locations, etc.), dates/times of the transactions, identifiers/names associated with the financial institutions, etc. In general, the transaction data includes various details of the transactions, which identify the transactions relative to other transactions, etc.

In this example embodiment, the travel providers 104a-b include airline providers, which offer air travel, or flights, from origin locations to destination locations. The travel provider 104a, for example, is configured to operate hundreds or thousands of flights through one or more airlines, which fly locally, or across countries, oceans or continents. In connection therewith, the travel provider 104a is configured to offer seats for sale to users, who, in turn, purchase tickets for the seats to travel from origin locations to the destination locations. In this example embodiment, the tickets for the seats are part of a core service purchased from the travel provider 104a, where core is intended to mean basic or essential. In addition to that core service, then, the travel provider 104a is configured to offer ancillary services for the tickets, where ancillary means extra or in addition to the core services. That is, all transactions must include at least one core service, and may include one or more, or no, ancillary services. Ancillary services may include upgrades from economy to economy plus, or to business class or to first class, etc. Other ancillary services permit the users to select or reserve specific seats on the airplanes (i.e., seat reservations), or to bring baggage or extra baggage along for the flights, etc. Still other ancillary services includes meals, WI-FI connectivity, etc. As indicated above, ancillary services may be considered any service or product in addition to a core, or basic, or fundamental service or product. It should be appreciated that, in this example embodiment, the travel provider 104b is configured in the same manner.

That said, in other example embodiments, it should be appreciated that the travel providers 104a-b may be other than airline providers and provide other types of travel or services to users, which, in turn, are also associated with ancillary services.

Based on the above, it should be appreciated that the transaction data my be indicative of purchases of core services for the users, ancillary services, or combinations of core and ancillary services. As such, the amounts included in the transaction data my be for any type of services, or combination thereof. In general, the transaction data does not include indicators, or other data, which identify which core/ancillary services were purchased and/or the apportionment of the amount to those services.

Apart from the transaction data, the database 106 includes data related to the operations of the travel providers 104a-b, including, for example, flight schedules, route data, airplane data (e.g., aircraft types, seating charts, etc.), listings of ancillary services (e.g., class types, etc.), price lists (e.g., standard baggage fees, meals, WI-FI access, etc.), etc.

In connection with the above, then, the processing network 102 includes a derivation architecture platform 108, which is at least one computing device configured, by executable instructions, to access available data, to process that data consistent with the description below, and to derive data indicator(s) that are instructive of one or more targeting strategies for the ancillary services.

In particular, in the illustrated embodiment, the derivation architecture platform 108 is configured to identify transactions for a specific type of travel, which may include, for example, transatlantic, transpacific, etc. travel, based on certain rules. For example, for transatlantic flights, the derivation architecture platform 108 may be configured to identify all transactions with the travel provider 104a with a charge amount above a defined threshold (e.g., $1000, etc.). The derivation architecture platform 108 is then configured to check for subsequent transactions in a region outside of a native region of the payment account. That is, where substantially all transactions for a user are in a state, or postal code or a region, and then subsequent transactions are in a different state or region in Italy, the derivation architecture platform 108 is configured to identify the Italy transactions as indicative of travel, and then based on the Italy transactions, to identify the purchase with the travel provider 104a as being a transatlantic flight from an origin in the United States (i.e., consistent with the state, postal code, or region in which substantially all transactions are located) to a designation in Italy.

The derivation architecture platform 108 is configured to also identify transactions for specific types of travel for the travel provider 104b, and other travel providers, to define a data structure of trans-Atlantic flight purchases, in this example (e.g., within the data structure 106, etc.), and further to define a data structure of other types of travel (e.g., trans-Pacific, intercontinental, etc.). As such, the identified flight transactions are not limited to one travel provider 104a, but include transactions from all travel providers where transactions for travel are processed through the payment processing network 102.

It should be appreciated that various logics and data may be employed (similar to the above) to identify transactions as flight transactions to certain locations (e.g., intercontinental, etc.) (e.g., origination and destination locations, price thresholds, etc.).

Next, the derivation architecture platform 108 is configured, using a machine learning model (e.g., a decision tree, etc.), to identify ancillary services in the transactions based on pricing associated with core services. In particular, in this exemplary embodiment, the derivation architecture platform 108 is configured to train the machine learning model based on a training data set of various features indicative of known purchases of core services and ancillary services (e.g., transactional features, etc.) to teach the model to differentiate between flight (or core) transactions and ancillary transactions. Example features included in the training data set may include, without limitation, transaction identifiers (IDs) (e.g., unique identifiers for each of multiple transactions, etc.), transaction amounts (e.g., monetary values of the transactions, etc.), transaction dates and times (e.g., when the transactions occurred, relative transactions (e.g., transactions of less amounts occurring weeks or months after an initial transaction of a larger amount, etc.), etc.), airline data (e.g., details such as merchant country, airline name, departure date and arrival locations, flight class, etc.), service details (e.g., details relating to ancillary services purchased (e.g., baggage fees, seat selections, etc.), etc.), etc.

In connection with the above, the data used in forming the training data set may come from organizations in the travel industry that log customer transactions. In addition, or alternatively, the data used in forming the training data set may come from publicly available datasets of travel agencies or airline companies, as well as from websites (e.g., datasets from the KAGGLE source, etc.) or government transportation databases. That said, if such actual data is not available for training, synthetic data may be generated based on known patterns in transaction behavior (e.g., using statistical methods to create realistic datasets that mimic expected transaction distributions, based on collected data through surveys that provide insights into customer behavior regarding flight and ancillary purchases, etc.).

Further, in connection with the above, and the decision tree model, spend (or amount spent) may be a continuous variable whereas origin and destination may be categorical variables representing the locations involved in the transactions. Categorical features (e.g., origin and destination, etc.), then, are encoded into numerical format, typically using techniques such as one-hot encoding or label encoding. Missing values in any feature may be addressed through imputation or removal of affected data. The dataset is recursively partitioned based on the selected attributes until certain stopping criteria are met, such as all instances in a node belong to the same class, or a maximum tree depth is reached, or a minimum number of samples per leaf node is specified, etc. To do a model evaluation, at the outset, the training dataset is divided into training and testing sets (e.g., 80/20 split). Accuracy, precision, recall, and F1-score may be used to evaluate model performance on unseen data. And, a confusion matrix may be generated to visualize true positives, false positives, true negatives, and false negatives across the categories.

In use, the machine learning model defines a classification tree algorithm, in which each of the transactions is classified, initially, as either a core service transaction or an ancillary service transaction, or a combination thereof. The classification tree algorithm then includes a further classification of the ancillary transactions into different types of ancillary transactions (e.g., baggage fees, seat reservations, WI-FI access, meal upgrades, etc.). In this way, the classification tree algorithm includes two types of classification.

In various examples, defining the classification tree algorithm may include data preparation, tree building, recursive partitioning, pruning and prediction, etc. For instance, a first step may include feature selection, to identify relevant features (such as those listed above) to be used to distinguish between flight (or core) transactions and ancillary transactions. Labels are assigned to each transaction as either flight/core or ancillary based on spend, origin and destination location, etc. The entire dataset may then be used as the root node. Next, a first measure (e.g., Gini Impurity, etc.) is used to measure how often a randomly chosen element is incorrectly labelled in the event of random labeling according to the distribution of labels in the subset. A second measure (e.g., entropy, etc.) is also used to measure the impurity in a dataset, while a third measure (e.g., information gain, etc.) is used to measure how much information a feature gives about the class label. In connection therewith, the classification tree algorithm selects the feature that results, for example, in the highest information gain or lowest Gini impurity for splitting. The dataset is next be split into subsets based on selected features and associated values. This process generally continues recursively for each subset until either all instances in a subset belong to the same class (pure node) or no further useful splits can be made (e.g., all features have been used, etc.). In various examples, to avoid overfitting, pruning techniques may be applied after building the tree (e.g., stop splitting when further splits do not improve model performance, etc.). Further, branches may be removed that have limited importance for the fully grown tree. Then to classify new transactions, the derivation architecture platform 108 is configured to traverse the tree from the root to a leaf node based on feature values of the new instance. The class associated with the leaf node may be assigned to the transaction. In some examples, ensemble methods (e.g., Random Forests, etc.) may further be used in combination with the classification tree algorithm.

In connection with the above, for example, for a flight transaction for a transatlantic flight from New York, New York to Rome, Italy, the derivation architecture platform 108 is configured to identify the core service cost as being approximately $600, based on a lowest flight transaction for the flight time/date, etc. The derivation architecture platform 108 is configured, using the machine learning model, to then determine a difference between the amount of the flight transaction and the core service cost, which is then identified as spend on ancillary services.

In addition, the derivation architecture platform 108 is configured to cluster (e.g., via K-means clustering, or otherwise, etc.) the users associated with the identified flight transactions into groups of users, and to then map the clusters of users into specific segments. The segments (or groups) of users may include, for example, without limitation, fun seekers, upscale players, affluent contractors, professional travelers, commuting professionals, elite vacationers, and wealthy, etc. In general, each cluster of users is mapped to the segment through criteria thresholds, which encompass, for example, the type of travel purchased, amount spent on travel, location, travel frequency, purpose of travel, regularity feature (e.g. common routes, etc.), details of non-travel spend (e.g., amount, merchants, balance, lifestyle choices, age, gender, etc.), and other data included in the transaction data for the user's payment account that is indicative of a category of traveler, etc. For instance, a user who spends high on categories such as accommodations, car rentals, dining, and transportation services, along with taking frequent airline trips each year, may be categorized as a “Professional Traveler.” Such a user may typically have a high household income, for example, surpassing $250,000 annually, which indicates their professional standing and financial capacity.

With the above segments, the derivation architecture platform 108 is configured to access the transaction data from the database 106 for an account, or specifically, a user, and then to classify, based on the accessed transaction data, the user into one of the segments.

Next, the derivation architecture platform 108 is configured to access core services and assess the ancillary services, per travel provider 104a-b, for the segment(s) of users.

In particular, for a specific segment, the derivation architecture platform 108 is configured to define a nine-box representation of the ancillary services for a target travel provider as compared to competitor travel providers. That is, the boxes along one axis include 0, 1, or greater than one ancillary transaction for the target travel provider, and the boxes along the other axis include values for the ancillary services for the competitor travel providers (e.g., individually or in aggregate, etc.).

The derivation architecture platform 108 is configured to impose rules-based decisions to notify the travel provider 104a, for example, of high, medium or low volume of transactions for ancillary services for the specific type of travel (or group of specific types of travel, individually) and the segment of users (or across all segments of users, individually). As such, the travel provider 104a, for example, may be informed about performance in ancillary service transactions (in general, or by type), relative to the travel provider 104b, for example, along specific routes, or for types of travel, for each of the specific segments of users identified above. The derivation architecture platform 108 is configured to notify the travel provider 104a, for example, about lagging in-seat reservation type ancillary services for transatlantic flights for commuting professionals, as compared to one or more competitors. In this way, the derivation architecture platform 108 is configured to derive data indicators, generally, which may be provided to the respective travel providers.

In this example embodiment, the derivation architecture platform 108 is configured to also identify a region of the users, from the transaction data in the database 106, based on additional transactions of the users. That is, the derivation architecture platform 108 is configured to determine that a threshold percentage of a user's transactions are in a specific postal code, city, or other defined region, etc. (or alternatively, to average the location of the transactions and to identify that average location to a region). The derivation architecture platform 108 is configured to then assign the user to that region. In turn, the derivation architecture platform 108 is configured to identify the airports, for the travel providers 104a-b, in or around the region (i.e., the airport that services the region, etc.).

The derivation architecture platform 108 is configured to filter the users by the specific airport of travel, in the region, whereby the travel provider 104a (or travel provider 104b) is informed of high, medium or low volumes of transactions for ancillary services, for the segment of users and also for the region in which the users reside.

The derivation architecture platform 108 may then be configured to inform the travel provider 104a, not only about the volumes of ancillary transaction, but the geolocation of the specific users in the specific segment. The derivation architecture platform 108 may be configured to further inform the travel provider 104a about further details of the users, based on trends in the transaction data, such as, brand loyalty, affluence, etc.

Based on the data from the derivation architecture platform 108, the travel provider 104a may then be configured to direct communications to the users offering incentives for the travel provider 104a, or the specific ancillary services to be increased. For example, the travel provider 104a may then be configured to provide an incentive, via email, SMS, etc., to a user to take advantage of one or more ancillary services (e.g., a seat upgrade, etc.), whereby the incentives are targeted to the specific user. The incentives may include discounts, rewards, etc.

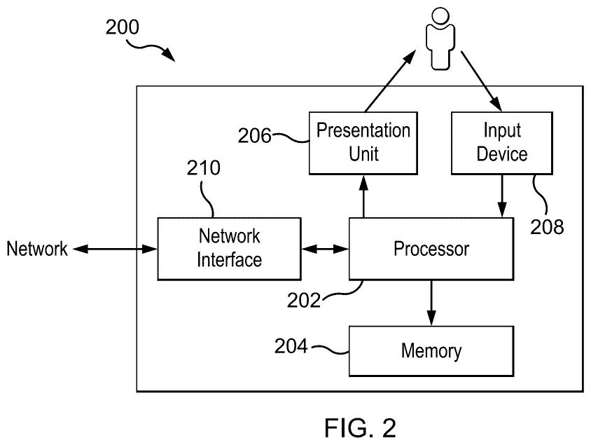

FIG. 2 illustrates an example computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the processing network 102, the travel providers 104a-b, the database 106, and the derivation architecture platform 108, for example, include or are included in, or integrated with, a computing device consistent with computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, segments, transaction data, machine learning models, threshold, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is operating as described herein, whereby in performing such instructions the computing device 200 is transformed into a special-purpose computing device. It should be appreciated that the memory 204 may include a variety of different memories, each implemented in one or more of the functions or processes described herein.

In the example embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., insights, data indicators, etc.), either visually or audibly to a user of the computing device 200, for example, a user associated with the travel provider 104a, etc. It should be further appreciated that various interfaces (as described herein) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user input.) such as, for example, requests for insights, trends, identification of specific types of travel, etc. The input device 208 is coupled to the processor 202 and may include, for example, a keyboard, a pointing device, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to one or more different networks. Further, in some example embodiments, the computing device 200 may include the processor 202 and one or more network interfaces incorporated into or with the processor 202.

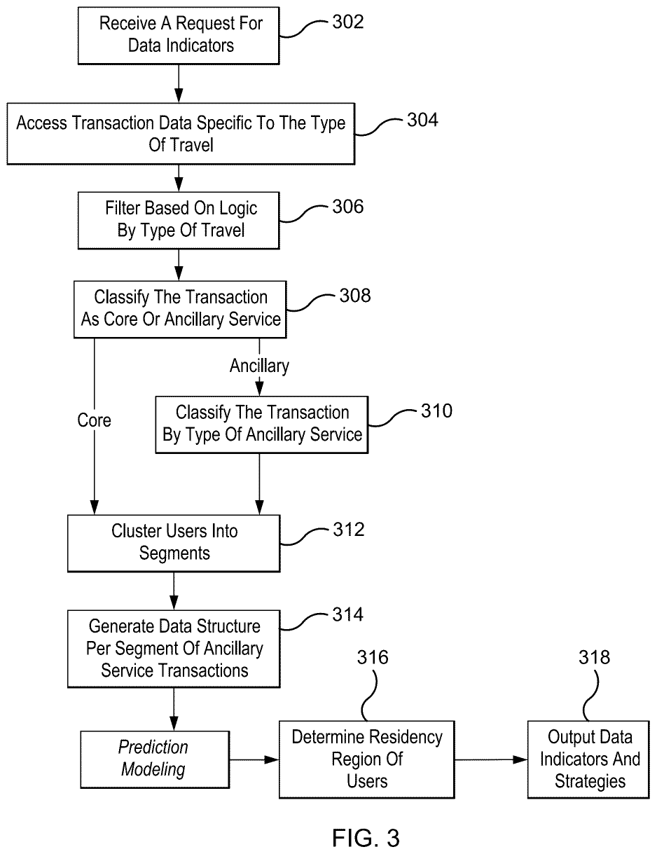

FIG. 3 illustrates an example method 300 for derivation of enhanced data indicators. The example method 300 is described with reference to FIG. 1 as implemented in the derivation architecture platform 108, and also with reference to the computing device 200. However, it should be understood that the methods herein are not limited to the example system 100 or the example computing device 200. Likewise, the systems and the computing devices herein should not be understood to be limited to the example method 300.

At the outset in the method 300, it should be appreciated that travel providers 104a-b provide flights to users, whereby the database 106 includes thousands, millions, or tens of millions, or more or less, transaction entries, specific to payment accounts, with the travel providers 104a-b. Additionally, the database 106 includes thousands, millions, or tens of million, or more or less transaction entries, specific to the same payment accounts, with other merchants (e.g., gas stations, pharmacies, grocery stores, clothing stores, restaurants, etc.). Regardless of the merchant involved, each transaction entry includes the details of the transaction (e.g., amount, MCC, date/time, location, merchant name/identifier, etc.).

In connection with the above, the travel provider 104b seeks data indicators related to the ancillary services offered by the travel provider 104b, upon which the travel provider 104b may decide to take an action (e.g., bundled offers, optimal pricing, personalize messaging, personalized rewards/marketing/incentives, etc.), etc. The sought after data indicators may be selected by the travel provider 104b, such as, for example, related to transatlantic travel, etc., or they may be unselected, whereby the derivation architecture platform 108 may select the specific data indicators based on the analysis described below. As it relates to the later, the derivation architecture platform 108 may have default types of travel (e.g., Caribbean, Middle East, Africa, domestic, transpacific, Australia, United States, etc.), which may be based on different destinations or groups of destinations. The types of travel may be limited to a region or origin, or not.

At 302, the derivation architecture platform 108 receives the request for data indicators from the travel provider 104b. The request, in this example embodiment, includes a request for data indicators in the specific type of travel, i.e., transatlantic air travel. Again, the request may be broad to additional types of travel, generic or specific to a destination, generic or specific to an origin, etc.

At 304, the derivation architecture platform 108 accesses transaction data, from the database 106, where the data is specific to the types of travel. In this embodiment, the transaction data may be limited to transactions in the airline/travel MCC, which includes transaction amounts in excess of a defined threshold, such as, for example, $600, in the last two years. This transaction data includes, consequently, various transaction entries for the travel providers 104a-b, as each operates multiple flights from the United States across the Atlantic, and vice-versa.

It should be appreciated that other thresholds and/or criteria may be used to access the transaction data in other embodiments. What's more, any suitable criteria may be used to initially limit the access of the transaction data, or to later filter the transaction data after access.

The derivation architecture platform 108 may further access knowledge data from the travel providers 104a-b, such as, for example, cost data associated with ancillary services (e.g., extra baggage fees, seat reservations, WI-FI access, etc.). An example listing of ancillary cost data accessed by the derivation architecture platform 108 is presented in Table 1 below.

TABLE 1
Travel Provider 104b

| | |
|---|---|
| Seat Reservation | $50 |
| Early Check in | $15 |
| WI-FI Access | $10 |
| First Extra Bag | $25 |
| Second Extra Bag | $35 |
| Ticket Change Fee | $75 |

It should be appreciated that other data may be accessed in connection with accessing the transaction data from the database 106, as apparent from the description below.

In this example embodiment, the derivation architecture platform 108 then filters, at 306, through specific logic to determine which travel purchases are indeed consistent with the type of travel, i.e., transatlantic air travel. For example, for each transaction accessed, the derivation architecture platform 108 accesses later transactions to the same payment account to which the travel transaction is directed and determines whether any transactions originate in countries across the Atlantic, different from a native region of the payment account (e.g., where a substantial number of transaction originate, etc.). If the payment account's native region is in the United States, and subsequent transactions originate in Paris, France, the travel purchase is retained based on the filter as a transatlantic air travel.

It should be appreciated that other logic may be employed to filter out transactions inconsistent with a type of travel to which the data indicators are directed.

Next, using a trained machine learning model, the derivation architecture platform 108 classifies, at 308, the transactions initially as either core services (e.g., tickets, base fares, etc.) or ancillary services, and also, classifies, at 310, the transactions for ancillary services into the types of ancillary services (as listed in Table 1, for example). In particular, the derivation architecture platform 108 employs a decision tree model, which accesses the transaction data specific to the transaction and performs the first and second classification. In this example embodiment, the classification decision of the tree initially relates to the amount of the transaction, but may further rely on the timing of the transaction (alone or relative to other transactions, etc.), origin and destination locations for the underlying travel, etc. For example, a transaction of less than a threshold amount (e.g., about 80%, etc.) is not generally going to be a transaction for a core service, which is based on a minimum flight cost for the relevant travel provider 104b.

As shown in FIG. 3, the derivation architecture platform 108 then clusters, at 312, the users and/or payment accounts for which transactions are classified as for ancillary services. That is, each of the transactions classified as an ancillary service transaction is specific to a payment account, and that payment account includes many other transactions. The transactions are associated with movie theaters, restaurants, apparel merchants, telecommunications, insurance, construction, home improvement, financial services, utilities, nightclubs, live events (e.g., concerts, sports, etc.), etc. The derivation architecture platform 108 is configured to compile a profile for each of the payment accounts, based on one or more of these types of data, and then to apply a K-means clustering to the payment accounts to define different segments of the users to which the payment accounts are issued. For example, a communication professional may have a high spend on airline travel, rental cars and city transits, while an upscale user may have high spend in insurance, dining and utilities, etc. In this way, through the clustering, the users are separated into the different segments, which may be formed from the users, or predefined by the derivation architecture platform 108.

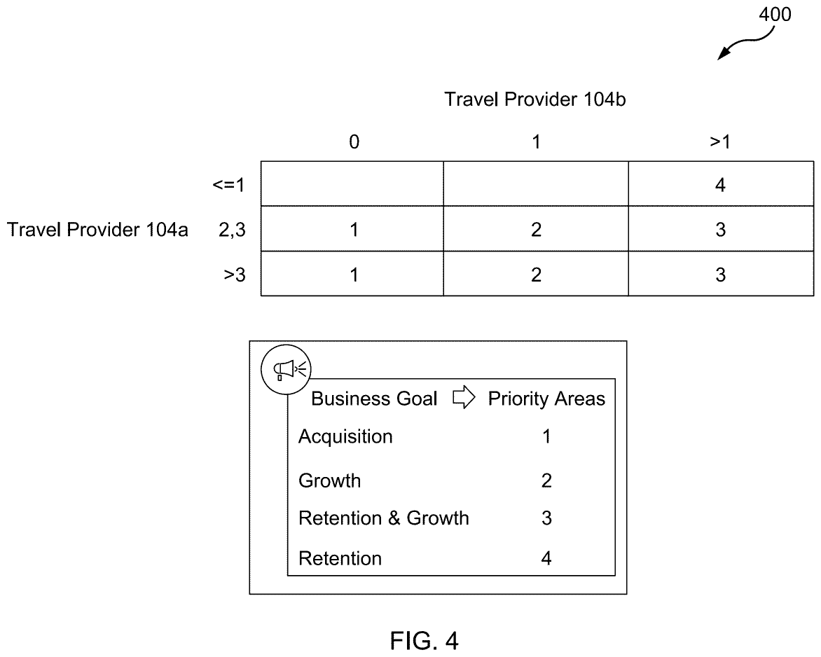

Next, for each segment (and each type of travel, as appropriate), the derivation architecture platform 108 compile, at 314, a data structure, which represents the ancillary service transactions for users with the travel provider 104b, and competitor travel providers, such as, for example, travel provider 104a. FIG. 4 illustrates an example data structure 400, in which the counts of ancillary service transactions are indicated. As shown, the data structure 400 is defined by rules indicative of spend and frequency. As apparent from the data structure 400, for the given segment of users, the travel provider 104b performs well with more than one ancillary service transaction, as compared to the competitor travel provider 104a. The data structure 400 aids the travel providers 104a, 104b in identifying opportunity areas and align business goals with each of the listed segments. It should be appreciated that the derivation architecture platform 108 compiles a data structure similar to the data structure 400 for each of the segments.

In some example embodiments, one or more predictive models are developed and used to estimate airline market size for different segments such as professional travelers, truly wealthy travelers, fun-seekers, etc. In doing so, the predictive model(s) analyze spending patterns, travel behavior, and demographic characteristics to provide insights into market potential for each segment. Various data may be used in developing/building the predictive model, for example, transactional data (e.g., information on past transactions including spend amounts, types of services used (e.g., flights, hotels, car rentals), and frequency of travel, etc.), demographic data (e.g., age, income level, occupation, and geographic location of travelers, etc.), market trends (e.g., insights into industry trends, economic indicators, and consumer preferences affecting travel behavior, etc.), etc. In connection therewith, linear regression is used to predict spending based on independent variables such as, for example, segment type, demographics, and historical spending patterns. As above, in connection with training, the training dataset may then be split into training and testing sets (e.g., 80/20 split, etc.), and the model then trained using the training set and validated using metrics such as mean absolute error (MAE) or root mean squared error (RMSE). Once the model is validated, derivation architecture platform 108 applies the trained model to project future spending patterns for each segment based on current trends. In turn, the total market size may be estimated by aggregating the predicted spends across all segments. Additional factors may be incorporated into the analysis and/or model training, such as economic conditions, seasonal trends in travel demand, and competitive landscape analysis.

Next in the method 300, the derivation architecture platform 108 determines, at 316, the residency region of the users associated with the payment accounts. That is, for example, the derivation architecture platform 108 accesses transaction data from the payment accounts, as described above, and determines an aggregate location of the transactions. In one example, the derivation architecture platform 108 averages the locations of purchase of certain types (e.g., gas, groceries, gym memberships, etc.), which are often indicative of a person's residency. In other examples, the derivation architecture platform 108 may employ other techniques to determine a residency of the users from the transaction data available through the processing network 102.

Then, at 318, the derivation architecture platform 108 outputs data indicators drawn from the data structure 106, per segment for the type of travel and potentially the residency of the users, and further indicates one or more strategies for the travel provider 104b to deploy as a competitive advantage (e.g., based on the residency of the users, etc.). For instance, with reference to FIG. 4 again, each box corresponds to a specific business goal for developing a targeting strategy. The business goals are categorized into Acquisition, Growth, Growth and Retention, and Retention. For the Acquisition targeting strategy, a “Try Us!” approach may be recommended to enhance market share, which includes pricing strategies and awareness campaigns. For the Growth targeting strategy, a “Welcome Back!” initiative may be suggested, focusing on incentivizing customers and increasing awareness of other travel routes offered by the provider. To achieve the Growth and Retention goal, a spend-threshold-based incentivization strategy may be proposed. And, for the Retention goal, a “Recognition and Thank You!” targeting strategy may be advised, utilizing a Surprise and Delight campaign.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a request for data indicators, from a first travel provider, accessing transaction data representative of a plurality of transactions, based on an amount of the plurality of transactions and a category of the first party involved in the plurality of transactions; (b) classifying the plurality of transactions as core service transactions or ancillary service transactions, using a machine learning model; (c) classifying the ancillary service transactions, using a second machine learning model, by type of ancillary service; (d) clustering users associated with the transactions into segments, based at least on non-travel transactions of the plurality of transactions; (e) for each segment, compile a data structure of a count of ancillary transactions for the first travel provider relative to one or more competitor travel providers; and/or (f) output one or more data indicators representative of the data structure, per segment, to the first travel provider.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for derivation of enhanced data indicators, the method comprising:
in response to a request for data indicators, from a first travel provider, accessing transaction data representative of a plurality of transactions, based on an amount of the plurality of transactions and a category of the first party involved in the plurality of transactions;
classifying, by a computing device, the plurality of transactions as core service transactions or ancillary service transactions, using a first machine learning model;
classifying, by the computing device, the ancillary service transactions, using a second machine learning model, by type of ancillary service;
clustering, by the computing device, users associated with the transactions into segments, based at least on non-travel transactions of the plurality of transactions;
for each segment, compile a data structure of a count of ancillary transactions for the first travel provider relative to one or more competitor travel providers; and
output one or more data indicators representative of the data structure, per segment, to the first travel provider.

2. The computer-implemented method of claim 1, wherein accessing transaction data includes accessing, from a processing network, the transaction data; and
wherein the plurality of transactions includes transactions to a plurality of different accounts issued to a plurality of different users.

3. The computer-implemented method of claim 1, further comprising filtering, by the computing device, the accessed transaction data based on one or more criteria, whereby the filtered transaction data is representative of only ones of the plurality of transactions specific to a type of travel.

4. The computer-implemented method of claim 3, wherein the one or more criteria are indicative of intercontinental travel.

5. The computer-implemented method of claim 4, further comprising receiving, by the computing device, the request for the data indicators from the first travel provider, wherein the data indicators are specific to the type of travel.

6. The computer-implemented method of claim 1, wherein the first machine learning model is a first, trained decision tree; and
wherein the second machine learning model is a second, trained decision tree.

7. The computer-implemented method of claim 1, wherein the ancillary services include multiple of: an upgrade service, a baggage service, a WI-FI access service, a seat selection service, and/or a meal service.

8. The computer-implemented method of claim 1, wherein clustering, by the computing device, users associated with the transactions into segments includes clustering the users, using K-means clustering.

9. The computer-implemented method of claim 1, further comprising determining a residency region of each of the users in one or more of the segments; and
wherein the one or more data indicators are specific to the residency region of one of the users in one or more of the segments.

10. A system for derivation of enhanced data indicators, the system comprising:
a computing device, which includes a memory and a processor, the processor configured to:
in response to a request for data indicators, from a first travel provider, access, from the memory, transaction data representative of a plurality of transactions, based on an amount of the plurality of transactions and a category of the first party involved in the plurality of transactions;
classify the plurality of transactions as core service transactions or ancillary service transactions, using a first machine learning model;
classify the ancillary service transactions, using a second machine learning model, by type of ancillary service;
cluster users associated with the transactions, based on accounts to which the transactions are directed being issued to the users, into segments, based at least on non-travel transactions of the plurality of transactions;
for each segment, compile a data structure of a count of ancillary transactions for the first travel provider relative to one or more competitor travel providers; and
output one or more data indicators representative of the data structure, per segment, to the first travel provider.

11. The system of claim 10, further comprising a processing network, which includes the at least one computing device; and
wherein the plurality of transactions includes transactions to a plurality of different accounts issued to a plurality of different users.

12. The system of claim 10, wherein the processor is further configured to filter the accessed transaction data based on one or more criteria, whereby the filtered transaction data is representative of only ones of the plurality of transactions specific to a type of travel.

13. The system of claim 12, wherein the one or more criteria are indicative of intercontinental travel.

14. The system of claim 12, wherein the processor is further configured to receive the request for the data indicators from the first travel provider, wherein the data indicators are specific to the type of travel.

15. The system of claim 10, wherein the first machine learning model is a first, trained decision tree; and
wherein the second machine learning model is a second, trained decision tree.

16. The system of claim 10, wherein the ancillary services include multiple of: an upgrade service, a baggage service, a WI-FI access service, a seat selection service, and/or a meal service.

17. The system of claim 10, wherein the processor is configured, in clustering, by the computing device, users associated with the transactions into segments, to cluster the users, using K-means clustering.

18. The system of claim 10, wherein the processor is further configured to determine a residency region of each of the users in one or more of the segments; and
wherein the one or more data indicators are specific to the residency region of one of the users in one or more of the segments.

19. A non-transitory computer-readable storage medium including executable instructions for derivation of enhanced data indicators, which when executed by at least one processor, cause the at least one processor to:
in response to a request for data indicators, from a first travel provider, access transaction data representative of a plurality of transactions, based on an amount of the plurality of transactions and a category of the first party involved in the plurality of transactions;
classify the plurality of transactions as core service transactions or ancillary service transactions, using a first machine learning model;
classify the ancillary service transactions, using a second machine learning model, by type of ancillary service;
cluster users associated with the transactions, based on accounts to which the transactions are directed being issued to the users, into segments, based at least on non-travel transactions of the plurality of transactions;
for each segment, compile a data structure of a count of ancillary transactions for the first travel provider relative to one or more competitor travel providers; and
output one or more data indicators representative of the data structure, per segment, to the first travel provider.
